(19) United States
(12) Patent Application Publication
(10) Pub. No.: US 2007/0221838 A1
(43) Pub. Date: Sep. 27, 2007

(54) Add-on device with sample injection tip for mass spectrometer

(75) Inventors: James H. Lenke, Morgantown, WV (US); Matthew Powell, Morgantown, WV (US)

Correspondence Address: Spillman Thomas & Battle PLLC;c/o Intellevate, P.O. Box 52050, Minneapolis, MN, 55402, US

(73) Assignee: Protea Biosciences, Inc., Morgantown, WV (US)

(21) Appl. No.: 11/388,193

(22) Filed: Mar. 23, 2006

(51) Int. Cl. H01J 49/04

(52) U.S. Cl. 250/288

(57) ABSTRACT

An add-on device which cooperates with a mass spectrometer to realize unique approaches to sample preparation, sample injection, and interchangeability among samples and users. The add-on device includes a sample injection tip adjacent an optional chromatography capillary column (“nano”) and a high voltage source, with the sample injection tip being fed from a sample source which is optimally treated by one, two or three sample preparation components as governed by one or more switching valves and associated electronics including a computer.

### BACKGROUND OF THE INVENTION

1. Field of the Invention

The invention is an add-on unit for a mass spectrometer which provides enhanced integrated sample preparation and injection into a mass spectrometer.

2. Description of Related Art

Heretofore, it has been atypical to combine mass spectrometer sample preparation and sample injection in a single system or device. In part this is attributable to the very different scientific traditions of sample preparation—generally wet chemistry of some kind—versus the traditional biophysics of mass spectrometer sample injection and analysis. However, the prior art combination of sample preparation and injection is not unknown. For example, U.S. Pat. No. 6,942,793 discloses a liquid chromatography mass spectrometer in which a number of devices are combined in a single system. These devices include a pump; sample injector; plurality of separation columns including a first separation column and a second separation column, and; a mass spectrometer. More particularly, this system includes a plurality of trap columns for retaining a sample component separated by the first separation column and a first switching valve for switching among one of the plurality of trap columns and another one of the plurality of trap columns at regular time intervals in such a way that when one of the plurality of trap columns is connected to the first separation column, another one of the plurality of trap columns is connected to the pump, and vice versa. A second switching valve enables a trap column, that is connected to the pump, to be further connected to the second separation column after connecting the trap column to solution discharging means during a predetermined initial time period, with the second separation column being connected to the mass spectrometer and capable of separating the sample component in a shorter time than the first separation column. Overall, U.S. Pat. No. 6,942,793 identifies the general benefits of combining sample preparation and injection in an overall coordinated system—a system to which the present invention nonetheless provides significant additional advantages as explained herein.

Continued challenges in sample preparation for mass spectrometry injection have to do with either or both of sample composition and/or contamination. For example, contamination in samples of interest is a serious problem in mass spectroscopy. Mass spectrometry samples are so small that, literally, the wave of an ungloved hand near an exposed sample or sample precursor can deposit, sight unseen, enough keratin or other proteins from shed skin to skew the composition significantly. Also, preparation of mass spectrometry samples of biological materials virtually always requires the removal of abundant proteins—such as the ubiquitous albumin—to enrich the relative concentrations of the peptides or proteins of interest, and such preparation in turn needs to be conducted in a way that is both fast and efficient. Interchangeability is an issue, too. Just as in past decades users had to schedule and share their use of mainframe computers, today, spectroscopy personnel need easy, efficient and contamination-free ways to share one big, expensive mass spectrometer. A need therefore remains for an integrated approach to mass spectrometry that provides for both optimal sample preparation and avoidance of contamination while at the same time making the mass spectrometer available to as many users as possible.

### SUMMARY OF THE INVENTION

In order to meet this need, the invention is an add-on device which cooperates with a mass spectrometer to realize unique approaches to sample preparation, sample injection, and interchangeability among samples and users. The add-on device includes a sample injection tip adjacent to an optional chromatography capillary column (“nano”) and a high voltage source, with the sample injection tip being fed from a sample source that is optimally treated by one, two or three sample preparation components as governed by one or more switching valves and associated electronics including a control panel, such as an LCD touch screen, all governed by a computer, such as a personal computer. Although the sample injector tip and two of the three sample preparation components are inherently unique and heretofore unknown, the invention is at the same time as much in the gestalt of the overall add-on device as it is in the individual novel components, particularly as it inheres in any mass spectrometry sample injection system which incorporates the instant unique sample injection tip. The sample injection tip, or ε-tip, has unique shape, material and dimensions; an optional gel electroelutor (GELutor) provides unique sample separation; and an optional tangential flow separator (PILFer) operates with the GELutor or alone to provide new and unexpected results in sample preparation and mass spectrometer injection.

### BRIEF DESCRIPTION OF THE DRAWING(S)

FIG. 1a is a side sectional view of an embodiment of the sample injection tip;

FIG. 1b is a perspective view along lines 1b-1b of FIG. 1a;

FIGS. 2a, 2b, 2c and 2d are side sectional views of four alternate embodiments of the present sample injection tip;

FIG. 3 is a close up sectional view of the terminus of a sample injection tip according to the present invention;

FIG. 4 is a schematic view which identifies the various required and optional components of the present add-on unit, of which the mass spectrometer 40 does not itself form a part;

FIG. 5 is a perspective view of an embodiment of the add-on device of the present invention;

FIG. 6 is a side sectional view of a gel electroelutor (GELutor);

FIG. 7a is a perspective view of a tangential flow separator (PILFer);

FIGS. 7b and 7c are horizontal and vertical sectional views of the device of FIG. 7a; and

FIG. 8 is a sectional view of the sample injection tip cartridge.

### DESCRIPTION OF THE PREFERRED EMBODIMENT(S)

The present invention is an add-on device that cooperates with a mass spectrometer to realize unique approaches to sample preparation, sample injection, and interchangeability among samples and users. The add-on device includes a sample injection tip adjacent an optional chromatography capillary column (“nano”) in line with a high voltage source, with the sample injection tip being fed from a sample source that is optimally treated by one, two or three sample preparation components as governed by one or more switching valves and associated electronics including an optical touch screen, such as an LCD touch screen. Although the sample injector tip and two of the three sample preparation components are inherently unique and heretofore believed to have been unknown previously, the invention is at the same time as much in the gestalt of the overall add-on device as it is in the individual novel components. The sample injection tip, or ε-tip, has unique shape, material and dimensions; an optional gel electroelutor (GELutor) provides unique sample separation; and an optional tangential flow separator (PILFer) operates with the GELutor or alone to provide new and unexpected results in sample preparation with or without added chromatography columns or other separators.

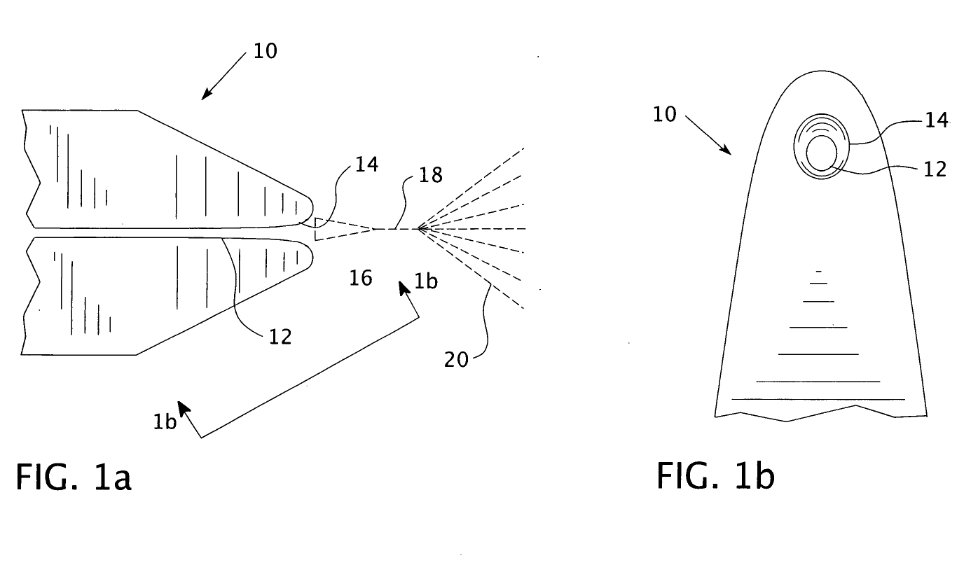

Essential to all embodiments and applications described herein is the sample injection tip, or ε-tip. The present sample injection tip is shown in FIGS. 1a and 1b. FIG. 1a is a side sectional view of the sample injection tip 10 having an aperture 12 therethrough which aperture widens to a bell 14. The sample travels through the aperture 12 and the bell 14 to create a “Taylor cone” 16 of electrospray ionized sample downstream of the bell, at the terminus of the sample injection tip, which Taylor cone narrows to a jet 18 of sample which in turn creates a sample plume 20 into the mass spectrometer. All types of electrospray ionized sample tips must create a Taylor cone properly to ionize the analytes such that once they are devolvated into gas phase ions, they can be steered by the magnetic fields controlled within the mass spectrometer. Without such a charge, the ions would not be directed by the ion optics for entrance into the mass spectrometer for subsequent detection.

FIG. 1b is a perspective view of the same tip as shown in FIG. 1a, shown in an upright position along line 1b-1b of FIG. 1a, showing the aperture 12 and the bell 14. Except for its unique bell-terminated aperture and material composition, the inventive sample injection tip is generally similar to other sample injection tips known in the art, as described below, although it is believed that the below-stated materials and dimensions contribute to the new and unexpected features attributable to this sample injection tip.

Traditionally, electrospray ionization (ESI) is used for the analysis of biological samples, such as proteins and peptides, that are susceptible to thermal degradation. Ionization of sample molecules is controlled by adjusting the pH of the solvent to manipulate protonation and deprotonation events. The basis for electrospray is the establishment of an electric circuit between the mass spectrometer and an electrode from the mass spectrometer in the flow path of the sample solution. A small air gap bridges the distance between the spray tip (sometimes called ESI tip emitters) and the mass spectrometer. When a voltage (1-to 5-kV) is applied to the sample solution flowing through the spray tip, a region of high charge density is produced at the tip.

Classically, the electrospray process is initiated as a “Taylor cone” of the sample (known in the art) that is formed at the terminus of a sample injector tip, due to the competing forces of the static electric field and the liquid's surface tension. At the point of the Taylor cone of the sample material, the sample liquid changes shape into a fine jet which, in turn, due to the charge density of the droplets in the jet, creates coulombic repulsion forces that repel the droplets away from each other, resulting in the production of an electrospray plume. Desolvation of the droplets in the plume, combined with coulombic repulsion, leads to the production of gas phase ions. The continuity of the electrical circuit is completed as the ions transit the air space to the mass spectrometer. As soon as the ions enter the mass spectrometer, they are directed to the ion trap by ion optics for subsequent detection and determination of their mass-to-charge ratio.

Historically, there have been several types of ESI tip emitters that have been used in mass spectroscopy in this way. Fused silica capillary can be heated and pulled into a fine point taper tip. Devices such as the Sutton Instrument laser puller can use laser light to heat the capillary while providing a pulling tension that draws the capillary into a much smaller diameter. When the stress point at the constriction becomes too much for the capillary, the constriction breaks into two sharp tips. New Objective and Nanogenesys produce capillary tip emitters in this fashion. Conductive coatings such as gold, silver and polyaniline can be placed on the ESI tips to permit direct connection of the electrode to the tip's exterior surface. Additionally, stainless steel tip emitters are available from Thermo Finnigan and New Objective. In the latter instances, small ID (inner diameter) stainless steel hollow tubes can either be fabricated with a small constant inner diameter or drawn down to fine tip points on one end. These tips are naturally conductive, and the spray voltage can be directly applied to the tip's surface. Advion has developed a silica ceramic spray tip emitter for static ESI mass spectrometry, in which fluid flow through the column is not controlled by hydrodynamic pumping. Instead, a small amount of sample solution is injected into the tubular end of the tip, and capillary action draws the sample solution towards the tip at very low flow rates.

Surprisingly, it has been found that when the inventive sample injection tip is configured with an outer blunt, rather than pointed, terminus, and with an aperture which flares into a bell as shown in FIG. 1a, electrospray ionization is vastly improved compared to the sharply pointed emitters of the prior art. As with all tips of this type, the structure is connected to a sample source via a feed line. It is believed that both the ceramic material used to create the present sample injection tip, and the unique shape, contribute to avoidance of arcing due to high voltages as well as superior electrospray ionization. It is also believed, without intention of being bound by the belief, that the reason prior art emitters are sharply pointed is to try to increase the electric field by maintaining the same voltage and decreasing the outer diameter of the tip to as small a point as possible. As it turns out, with the present sample injection tip, the necessary high voltages/electric fields are easily achieved.

Optimally, the sample injection tip is configured with an inner aperture diameter of between 25-38 micrometers, whereas at the outermost edge of the bell 14 the inner diameter is between 38-68 micrometers and the outerdiameter of the sample injection tip at its terminus is between 74-200 micrometers. Most preferably, the add-on device has a sample injection tip in which the aperture has an inner diameter of about 34±5 micrometers, the bell shaped void has a maximum inner diameter of about 55±5 micrometers, and the outer diameter of the terminus of said sample injection tip is about 135±5 micrometers. Within these dimensions, the sample injection tip can spray in both nanospray and microspray flow regimes due to the high efficiency promulgated by the ceramic material and the attendant shape and dimensions. Preferably, the ceramic is alumina (aluminum oxide), fused silica, alumina doped with zirconia or synthetic ruby (alumina doped with chromium oxide). The most preferred ceramics are the aluminas because they are less brittle and thus less breakable than other ceramic materials. With improved electrospray ionization, mass spectral quality is improved through reduction of the background noise, improvement of the signal/noise ratio and production of the relatively higher charge state ions of the sample. In FIG. 1a, the “Taylor cone” 16 of the sample, which entrains into the jet 18 and thence into the plume 20, can be visualized and, in side sectional view, the counterintuitive design of the aperture 12 and the bell 14 to generate such a Taylor cone, jet and plume, is readily apparent.

Not incidentally, the sample injection tips as described herein may be used in many applications, not just in mass spectrometry. The sample injection tips are appropriate anywhere a tiny sample of any material needs to be introduced, via electrospray ionization, into another environment, presumably but not necessarily for analysis. Sample injection for other types of spectroscopy are contemplated; industrial or medical sample transfers including patient treatments are, without limitation, also within the scope of the invention. Having said that, in the mass spectrometry context users can conservatively expect up to a 50% improvement in signal when using the present sample injection tip as contrasted with ESI emitters known in the art.

When the present sample injection tips are manufactured, they are formed of alumina (or any of the other above-listed ceramic materials) in combination with a binder, typically a polymer, cured into a green form, and sintered usually at about 2200 degrees Celsius.

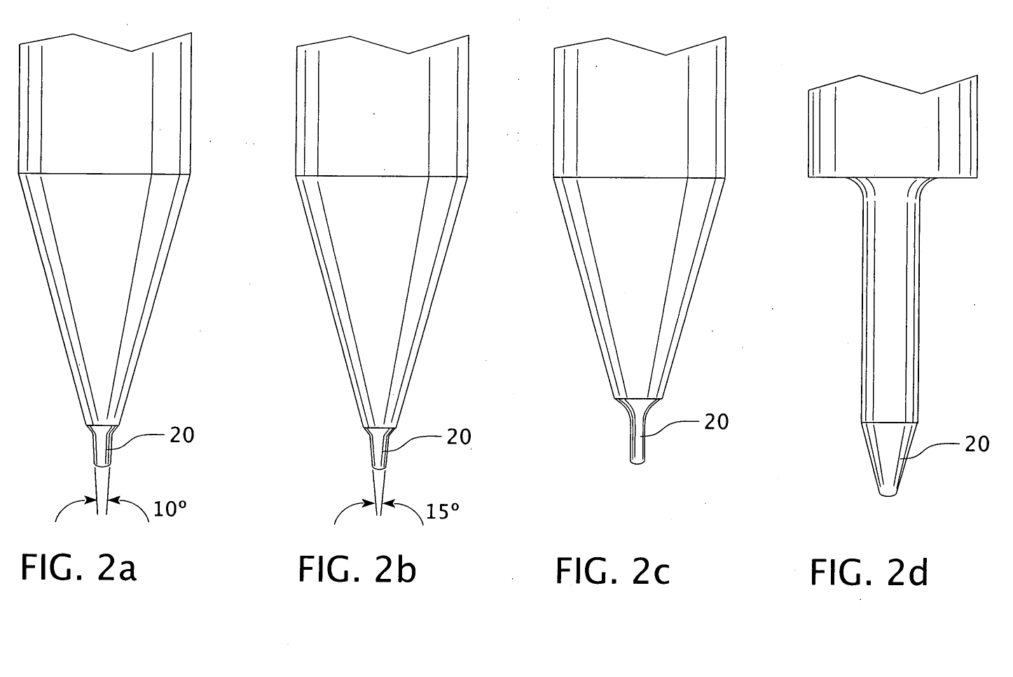

FIGS. 2a, 2b, 2c and 2d illustrate alternative sample injection tip shapes, shown in side sectional view. All of these alternative shapes are typified by the blunt terminus to the sample injector tip 20, as compared to the more sharply pointed tips of the prior art. Sample dimensions and Taylor cone angles are marked.

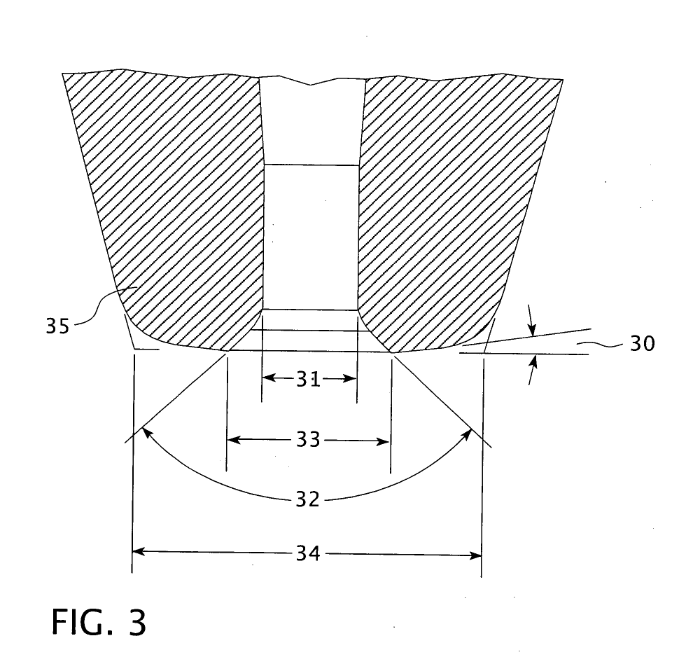

Finally, and referring once again to FIG. 1a, it should be understood that the aperture 12 may transition to the bell 14 with more or less taper than is shown in FIG. 1a. The degree of the taper is less important than the aperture and bell diameters. Interestingly, although for many inventions sizes are not particularly relevant, because of the nature of the sample injection tip and the molecular and ionic realities of the samples, dimensions are relevant to the tip invention. Referring now to FIG. 3, which shows a side sectional view of the same tip as shown in FIG. 1a except for its vertical orientation, the Face Angle 30 may range between 0 and 11 degrees; the aperture diameter 31 may range between 25 and 178 micrometers; and the chamfer diameter (or maximum bell diameter) 33 may range between 35 micrometers to 254 micrometers. With continued reference to FIG. 3, the chamfer angle (bell angle) 32 may range between 90 and 120 degrees; the outer diameter (tip terminus) 34 may range between 38 and 360 micrometers, and the outer radius 35, that is, the outer radius of the sample injection tip upstream of the terminus, is unlimited in size.

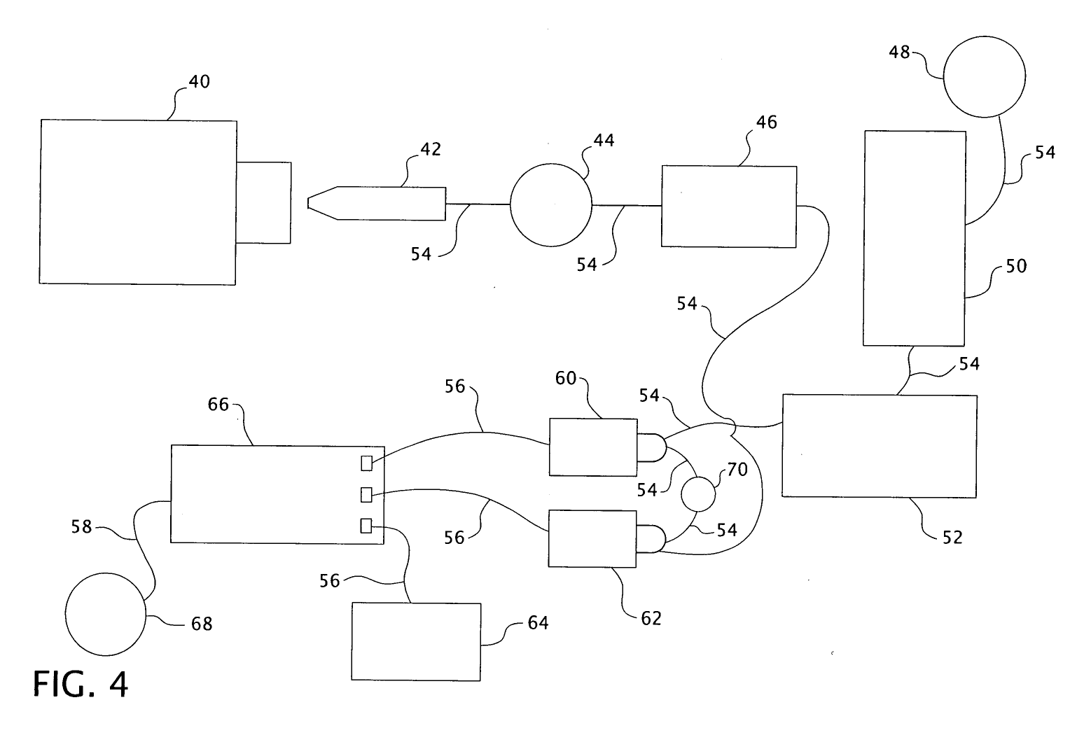

Referring now to FIG. 4, a mass spectrometer 40 (not part of the present add-on device) is positioned immediately adjacent a sample injection tip 42, with all cooperating mass spectrometer/tip adjunct equipment being known in the art. The sample injection tip 42 is connected, via one of many feed lines 54, to a C8 or C18 “capillary column” (nano) 44. The capillary column 44 is connected, via a feed line 54, to a high voltage source 46. Upstream, a syringe 48 allows material injection via a feed line 54 to an optional gel electroelutor (GELutor) 50, which is in turn connected via a feed line to a tangential flow separator (PILFer) 52, connected in turn to a first switching valve 60. Feed lines 54 interconnect the tangential flow separator 50 as shown, in combination (optimally) with a second switching valve 62 and an optional trap column (micro) 70. The switching valves are governed by a computer 68, such as a personal computer, via add-on device electronics 66, in turn connected to the switching valves 60 and 62 and an optional control panel 64, such as an LCD touch screen, via electronic connections 56. The switching valves 60, 62 are typically double pull, double throw type switching valves of which the valves in U.S. Pat. No. 6,942,793 are representative. The most typical embodiment of the invention includes one each of a six port and a ten port switching valve. Although there is inventive subject matter in the overall combination depicted in FIG. 4, the individual switching valves, electronics and electronic connections, and feed lines of FIG. 4 are well known in the art. It should be noted that a double pull, double throw two-position six port switching valve is common for use in connections adjacent mass spectrometers known at this writing. Many of the structures of the add-on device, such as a sample tray for storing tubes such as PCR tubes, are optimally all combined on a single tray type (platform) device that can be carried to and from the add-on unit by each individual user. Indeed, individual users may take advantage of a multiple of separate platforms and/or ESI assembly mounts for a variety of different projects, both for convenience and for avoidance of sample cross-contamination between projects. The add-on unit itself may be carried to and from the mass spectrometer. How the various structures described individually herein can be combined and subcombined will be readily apparent from the figures.

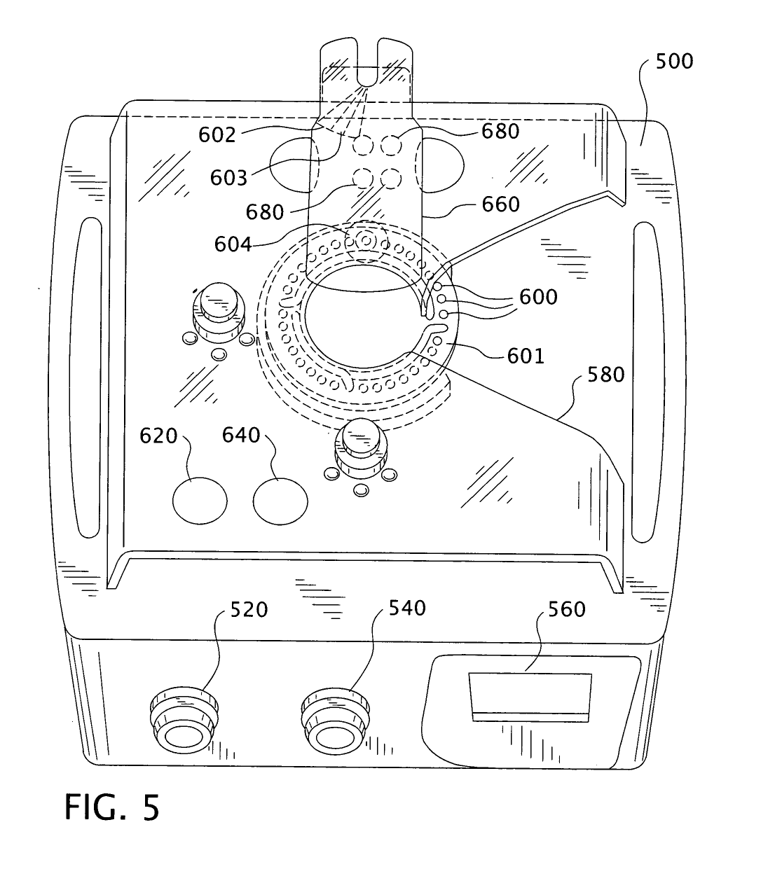

Referring now to FIG. 5, the basics of the juxtaposition of the inventive add-on unit, a removable platform and a removable ESI assembly mount, as discussed in the previous paragraph, are shown in perspective view. The combination of the add-on unit, the platform and the ESI assembly mount yield a flexible and universal system that adapts to any user's laboratory routine and multiple chromatographic options in any permutation. FIG. 5 is for spatial illustrative purposes only, because the various combinations and potentially customized connections of the present add-on unit, whether facilitated with a portable platform or not, are readily apparent from FIG. 4. FIG. 5 shows the add-on unit 500 having a first switching valve 520 and a second switching valve 540 adjacent a touch screen 560. A snap-on platform 580 can be positioned over multiple sample storage tube receptacles 600 in a rotating annular sample tray 601 accessible in the add-on unit itself, under the platform 580. Gel electroelutor bracket 620 and tangential flow separator bracket 640 are simple apertures in the platform 580 and are designed to assist the spatial positioning of the gel electroelutor and tangential flow separator devices when either or both are placed in their respective aperture brackets. Any other configuration of bracket may be substituted. The ESI assembly mount 660 with its feet 680 sit atop and/or through corresponding apertures in the platform 580 to provide a stable surface near the multiple sample storage tube receptacles 600, to hold the structures of the ESI assembly including the triangular sample injection tip cartridge mount 602, the sample injection tip cartridge 603, the high voltage source (not shown) and the fraction collector inlet 604. The triangular sample injection tip cartridge mount 602, the sample injection tip cartridge 603, the high voltage source (not shown) and the fraction collector inlet 604 are all borne atop the platform 580 and underneath the top surface of the ESI assembly mount 660. The connecting feed lines and electronic connections, and electronics and computer connection (ethernet) are likewise not shown in this perspective view, and are well within the skill of the art for multiple permutations of all the possible components. Any number of additional chromatography columns or devices may be added to create any custom sample separation or preparation. Generally, all the feed lines and connections are provided in semi-permanent or permanent attachment to the add-on unit 500, so that the platform 580 may be detached at will from all the feed lines and connections and a different platform substituted therefor at any time. Commercially available PCR tubes, such as strips of banded PCR tubes customarily banded in rows of 8, may be placed in the sample storage tube receptacles 600 for filling as the sample tray 601 rotates as controlled by a motor and software, to eject a fraction of sample through the fraction collector inlet 604 and concomitantly into a sample storage tube (not shown).

The gel electroelutor (GELutor) of the present invention was designed to extract, reproducibly and efficiently, electrophoretically separated intact proteins from the SDS-PAGE (sodium dodecyl sulfate polyacrylamide gel electrophoresis) gel matrix. The design of the gel electroelutor (GELutor) incorporates the combination of electroelution and hydrodynamic flow to permit the successful, reproducible extraction of gel-separated proteins. Following electrophoretic separation of proteins on an SDS-PAGE gel, the proteins are visualized using a non-fixing stain (i.e., modified Coomassie or SYPRO orange stain). The protein bands are excised from the gel using a tubular spot picker, which is then inserted into a gel spot well in the GELutor body. The GELutor then uses a low applied voltage and flow through buffer to establish an electric field across the gel spot. The protein band electrophoretically migrates out of the gel and into the flow through buffer, which carries the extracted proteins out of the gel electroelutor for loading onto (typically) a C8 solid phase extraction trap. The specific GELutor body design, incorporating the electrodes for establishment of the cross-gel electric field and the channels for hydrodynamic pumping of flow through buffer, permit efficient and reproducible extraction of intact proteins from SDS-PAGE gels.

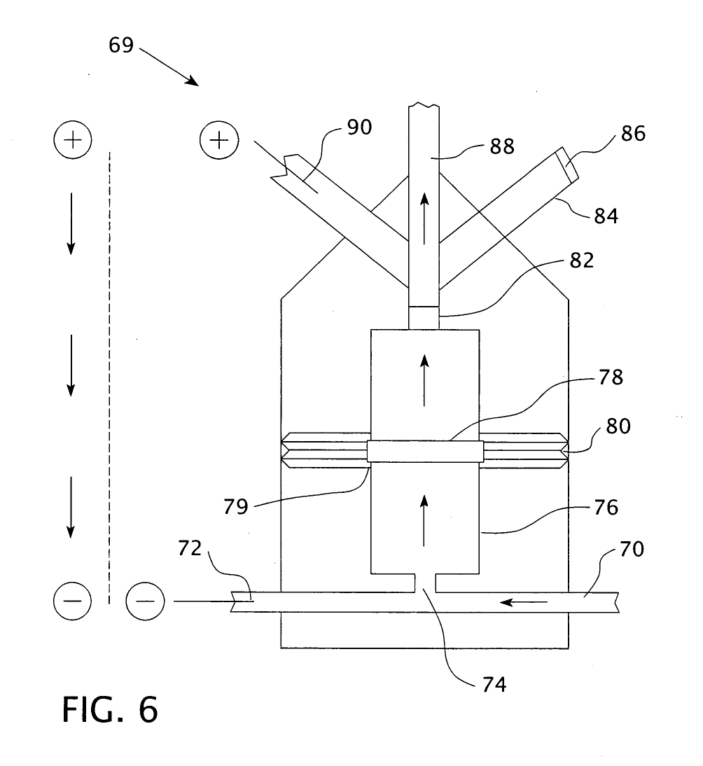

Referring now to FIG. 6, the gel electroelutor (GELutor) 69 of the present invention is illustrated in side sectional view. As described immediately above, a gel spot is cut with a tubular spot picker (similar to using a plastic straw to cut Jello) and the gel spot 78 is placed within a gel spot well 79, in the gel spot column 76 of the gel electroelutor 69. Upstream of the gel spot 78 is the syringe inlet 70; adjacent the syringe inlet 70 is a sealed positive electrode 72. Fluid, typically buffer without additional sample components, travels from the syringe inlet 70 to the gel spot column inlet 74 and from thence through the gel spot 78 to and through the frit plug 82. The frit plug prevents micron sized particles of gel from traveling downstream-frit plugs are known in the art and commercially available. Downstream of the frit plug 82 is a purge line 84 (for removing air bubbles, for example) which terminates in a purge line plug 86. Adjacent the purge line 84 is a sealed negative electrode 90. The electric field thus forms in the opposite direction to the fluid flow, and the protein band already having been determined to be of interest thus electrophoretically migrates out of the gel and into the flow through buffer, which carries the extracted proteins through the frit plug and further downstream to any desired further separation or preparation unit via the gel electroelutor outlet 88. It should be noted that prior art static tubes for gel spot electroelution never enjoyed the continuous flow advantage the present gel electroelutor affords. Also, with the gel spot 78 having a diameter which leaves no gap between the gel spot 78 and the gel spot well 79 (which is shown as an annular recess in the wall of the gel spot column 76), separations are enhanced as contrasted with prior art gel eluting tubes which allowed space between the gel and the tube wall and concomitant co-admixing of upstream and downstream flows. Additionally, a sweep line can be configured to the purge line port 84 to provide additional flow for removal of any protein sample remaining within the GELutor outlet line.

Downstream of the optional gel electroelutor described above is the also optional, but more generally ubiquitous, tangential flow separator, or PILFer. The PILFer (or Protein In-Line Filter) was developed to assist researchers in the concentration, purification, and preparation of protein samples for analysis. The PILFer device contains a molecular weight cut-off filter (MWCO) which effectively acts as a sieve for biological sample solutions. Analytes and solvent molecules whose size is below the MWCO pass through the membrane as the filtrate, while sample molecules whose size is above the MWCO are retained in the reservoir above the membrane as the retentate. Variable plumbing connections utilizing a standard switching valve permit collection of either the retentate or the filtrate for subsequent analysis. Inside the PILFer, the retentate can be rinsed, desalted, purified and concentrated. Additionally, the retentate reservoir can be used as a reaction chamber for fluorescent labelling of proteins and for reduction/alkylation of proteins prior to enzymatic digestion. Using an appropriate reagent, the PILFer can be used to remove SDS detergent from proteins trapped in the retentate reservoir.

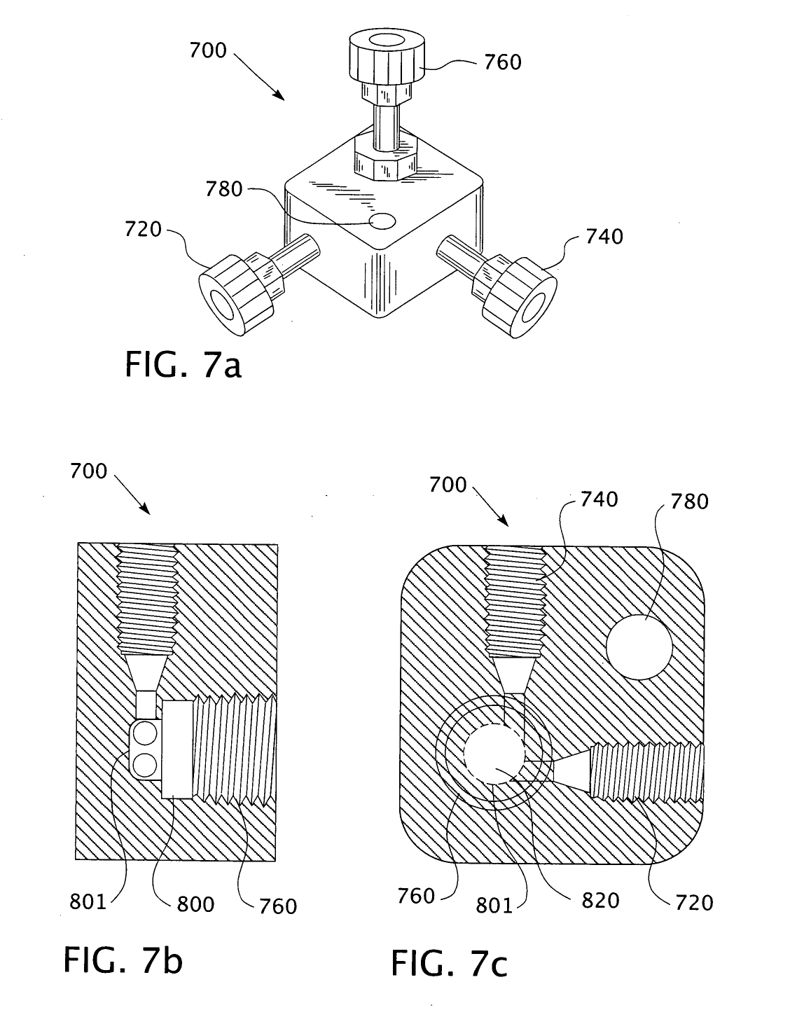

Referring now to FIG. 7a, a preferred embodiment of the PILFer is shown in external perspective view. The three ports of the tangential flow separator 700 may be color coded to signify inlet, filtrate and retentate, but the inlet port 720, the retentate port 740 and the filtrate port 760 are so numbered. Referring now to FIGS. 7b and 7c, horizontal and vertical sectional views of the tangential flow separator 700 show that a shoulder 800 where the MWCO membrane seals against is positioned adjacent the filtrate port 760, and hence all filtrate has passed through the filter. However, with particular reference to FIGS. 7b and 7c, it may be seen that the inlet port 720 and the retentate port 740 feed in an off-center, orthogonal orientation into a chamber well 801 (visible in dotted line in FIG. 7c due to the overlaying filter 820). The pressure of the sample solution entering the PILFer reservoir provides hydrodynamic pressure that pushes bulk solvent and other molecules below the MWCO through the membrane pores. Proteins and other larger molecules can become lodged in the membrane pores or adsorb to the membrane surface, leading to fouling of the membrane. The orthogonal orientation of the inlet flow creates a tangential, or sweeping, flow around the chamber well 801 that prevents proteins from experiencing a static downward pressure at the membrane surface, and thus reduces clogging events in the pores. Additionally, the orthogonal design improves flushing out of the chamber during retentate collection. The geometry of the PILFer inlet port 720 and the retentate port 740 create a cyclonic water flow during retentate collection, similar to the cyclonic flow when a commode is flushed. The cyclonic action produces a high tangential flow that helps to sweep adsorbed and lodged proteins from the membrane surface, thus improving protein sample recovery. The filter 820 is any MWCO filter as within the skill of the art. Typical filters of this type are paper discs with a polymer coating, such as a multi-layer polymer coating, in the side of the filter facing the chamber well 801. Pore size and compatibility features for such MWCO filters are well known, and filters of this type are available, for example, from Pall Corporation.

Prior to the present innovations, any functionalities similar to the present gel electroelutor (GELutor) and/or tangential flow separator (PILFer) were performed off-line. The present invention is therefore more than a mere automation of previously disparate operations: these two in line devices benefit enormously from a continuous flow system and the efficiency which continuous wet processing affords, as contrasted with largely dry separations in centrifuges according to the prior art.

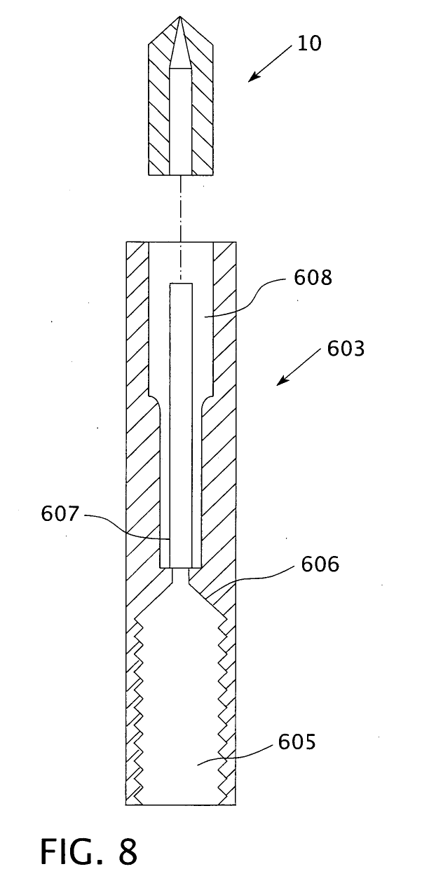

The present sample injection tip 10 may be combined with a sample injection tip cartridge 603, and its sample injection tip cartridge mount 602 (not shown), as further illustrated in FIG. 8.

FIG. 8 is a sectional view of a sample injection tip cartridge 603 with a threaded aperture 605, a center inlet 606, a center inlet tube 607, and a sample injection tip receptacle 608. Also, in this way the sample injection tip cartridge 603 may be borne in or on the sample injection tip cartridge mount 602, as shown in FIG. 5, which itself is mounted so as to be able to rotate laterally, to position the sample injection tip 10 at 0, 25 or 50 degree angles from the mass spectrometer entrance (with degrees being measured from a “z” axis straight into the entrance of the spectrometer).

The screen of a governing computer advantageous provides for 8 bullets (or buttons, or links), with one each for “electroelution,” “fraction,” “collection,” “digestion,” “separation” and “analysis.” Each of these links permits governance and upload of the associated software (and motor control and etc.) to support each of the eight functions so identified. The present invention thus embraces not only the above-described add on unit but also the method of governing the unit with eight key commands and upload functions.

Although the invention has been described with particularity above, with reference to particular structures, materials and methods, the invention is to be limited only insofar as is set forth in the accompanying claims.

The invention claimed is:

1. An add-on device with sample injection tip for a mass spectrometer, comprising a sample injection tip connected to a sample source via a feed line, wherein said sample injection tip is ceramic and has a tapering outer diameter and an aperture axially disposed therein, said aperture increasing in inner diameter to a chamfer adjacent the terminus of said sample injection tip, wherein said sample injection tip is positioned adjacent a high voltage source.

2. The add-on device of claim 1, wherein said aperture has an inner diameter between 25 and 178 micrometers; said chamfer adjacent the terminus of said sample injection tip has an inner diameter between 35 and 254 micrometers; and the terminus of said sample injection tip has an outer diameter of between about 38 and 360 micrometers.

3. The add-on device of claim 1, wherein said chamfer adjacent the terminus of said sample injection tip has an inner diameter between 38 and 68 micrometers and the terminus of said sample injection tip has an outer diameter of between about 74 and 200 micrometers.

4. The add-on device of claim 1, wherein in the sample injection tip the aperture has an inner diameter of about 34±5 micrometers, the chamfer adjacent the terminus of said sample injection tip has a maximum inner diameter of about 55±5 micrometers, and the terminus of said sample injection tip has an outer diameter of about 135±5 micrometers.

5. The add-on device of claim 1, wherein said ceramic is selected from the group consisting of alumina and fused silica.

6. The add-on device of claim 1, wherein said ceramic is selected from the group consisting of alumina, synthetic ruby (alumina doped with chromium oxide), and alumina doped with zirconia.

7. The add-on device of claim 1, wherein a gel electroelutor is provided upstream of the sample injection tip.

8. The add-on device of claim 7, wherein said gel electroelutor is in-line with the sample injection tip and is designed so that a gel spot fits in a gel well to avoid space between the gel spot and the adjacent column wall, and further wherein said gel electroelutor is positioned in a bracket on a platform.

9. The add-on device of claim 1, wherein a tangential flow separator is provided in-line and upstream of the sample injection tip.

10. The add-on device of claim 9, wherein said tangential flow separator has an inlet port, a filtrate port and a retentate port.

11. The add-on device of claim 10, wherein said tangential flow separator has a central well which receives the inlet port and the retentate port in an orientation both off-center and orthogonal to the center of said central well.

12. The add-on device of claim 11, wherein said tangential flow separator is positioned in a bracket on a platform.

13. The add-on device of claim 12, wherein an ESI assembly mount sits atop the platform and houses said sample injection tip.

14. The add-on device of claim 13, wherein said sample injection tip is mounted within a sample injection tip cartridge and said sample injection tip cartridge is positioned atop a triangular, rotatable sample injection tip cartridge mount.

15. The add-on device of claim 14, wherein said sample injection tip cartridge is connected to a high voltage source.

16. The add-on device of claim 15, wherein said high voltage source is positioned adjacent a fraction injection inlet.

17. The add-on device of claim 16, wherein said fraction injection inlet is located in said platform and is aligned atop a rotating sample tray having apertures therein.

18. The add-on device of claim 17, wherein all the assembled components are positioned adjacent the entrance of a mass spectrometer.

19. The add-on device of claim 18, wherein said sample injection tip cartridge contains an inner tube compatible with the upstream diameter of the sample injection tip and an outer inlet having threads on its interior.

20. The add-on device of claim 19, wherein the inlet port, retentate port and filtrate ports of the tangential flow separator are marked with different colors.

21. A device for sample preparation being adapted to receive a sample injection tip, comprising a feed line, a platform, at least one switching valve, and at least one of a gel electroelutor and/or a tangential flow separator.

22. A gel electroelutor having a gel spot well within a gel spot column connected to an inlet, an outlet, a purge line and a frit plug, said gel electroelutor having sealed positive and negative electrodes associated therein.
